(19) United States
(12) Patent Application Publication
(10) Pub. No.: US 2021/0350699 A1
(43) Pub. Date: Nov. 11, 2021

(54) Method for Vehicle Classification Using Multiple Geomagnetic Sensors

(71) Applicant: Xidian University, Shaanxi (CN)

(72) Inventors: Changle Li, Xi'an (CN); Yunpeng Wang, Xi'an (CN); Guoqiang Mao, Xi'an (CN); Yilong Hui, Xi'an (CN); Zhiqiang Chen, Xi'an (CN); Zhen Liu, Xi'an (CN); Yuexu Chen, Xi'an (CN)

(21) Appl. No.: 17/154,987

(22) Filed: Jan. 21, 2021

(30) Foreign Application Priority Data
May 11, 2020 (CN) 202010391089.4

(51) Int. Cl. G08G 1/042; G01B 7/04

(52) U.S. Cl. CPC G08G 1/042; G01B 7/046

(57) ABSTRACT

The invention discloses a method for vehicle classification using multiple geomagnetic sensors, which mainly solves the problems of high cost, complex processing process and difficulty in large-scale deployment of the existing vehicle classification methods. The method comprises the following steps: sequentially deploying N geomagnetic sensors on a road side at equal intervals d, each of the geomagnetic sensors respectively collecting magnetic field data around same, respectively transmitting the magnetic field data to a data processing module for storage, and judging whether a vehicle passes over a detection range of the sensors or not according to the data; calculating a time difference obtained when the vehicle passes by two adjacent sensors among N sensors, and calculating the vehicle speed and the vehicle magnetic length according to the time difference; setting a vehicle magnetic length double-threshold value and a Z axis magnetic field strength threshold value, acquiring Z axis geomagnetic data and the magnetic length that the vehicle passes by, comparing the Z axis geomagnetic data and the magnetic length that the vehicle passes by with the set threshold value, and acquiring a judged vehicle type result. According to the invention, the vehicle type information of the vehicle passing by can be accurately acquired, the reliability is high, the cost is low, large-scale deployment is easy to realize, and the method can be used for highway intellectualization.

### FIELD OF THE INVENTION

The invention belongs to the technical field of intelligent transportation, and further relates to a vehicle classification method which can be used for detecting types of motor vehicles on road and realizing highway intellectualization.

### BACKGROUND OF THE INVENTION

Traffic is a significant driving force of urban development. A rapid increase of vehicle reserves in China results in problems of traffic jam, traffic accidents and environmental pollution, etc. At the same time, urban transportation is rapidly developing towards intelligent transportation, and intelligent transportation systems (ITS) are also increasingly popular. Under this background, the Chinese government have issued a number of national strategic documents to point out that developing smart road technologies is a target of transportation development. As one of the basic attributes of vehicles, vehicle type information is significant for the construction of intelligent transportation system, and vehicle type detection technology, as an important part of intelligent highway, is widely used in the fields of intelligent driving assistance, intelligent monitoring, etc.

The vehicle type information of the vehicles on road is reliably detected and uploaded to the transportation management platform to provide real-time analysis on urban transportation conditions and guidance for the transportation management departments. The latest existing vehicle classification methods are studied as follows: H. Liu et al., “Vehicle Detection and Classification Using Distributed Fiber Optic Acoustic Sensing”, IEEE Transactions on Vehicular Technology, in which a distributed fiber optic acoustic sensor is used for vehicle classification; X. Tang et al., “Experimental Results of Target Classification Using mm Wave Corner Radar Sensors”, 2018 Asia-Pacific Microwave Conference (APMC), in which a millimeter wave radar is used for vehicle classification; N. Shvai et al., “Accurate Classification for Automatic Vehicle-Type Recognition Based on Ensemble Classifiers”, IEEE Transactions on Intelligent Transportation Systems, 2020, in which a Convolutional Neural Network (CNN) and a gradientrise-based classifier are used for vehicle classification; R. Theagarjan et al., “Physical Features and Deep Learning-based Appearance Features for Vehicle Classification from Real View Video”, IEEE Transactions on Intelligent Transportation Systems, 2020, in which depth learning is adopted to classify the types of vehicles based on physical and visual characteristics in rear-view video of vehicles.

In addition to the above methods, the works rotated to vehicle classification based on the geomagnetic sensor are as follows: a patent application No. CN 201911028008.8 discloses a transportation flow statistics and designs a vehicle classification device, wherein a difference image of a current frame and a background frame are obtained by acquiring a transportation flow video, and finally a vehicle type characteristic value is compared with a classification threshold value to obtain a vehicle classification result. A patent application No. CN 201711133396.7 discloses a vehicle classification method, system and electronic equipment based on a geomagnetic sensor, wherein a first original waveform data and a second original waveform data of a vehicle are respectively collected through two geomagnetic sensors, a length of the vehicle is calculated, a time domain characteristic value and a frequency domain characteristic value are extracted, and the time domain characteristic value and the frequency domain characteristic value are input into an SVM classification model for vehicle classification. A patent application No. CN 201010239807.2 discloses a vehicle type identification method based on a geomagnetic sensing technology, wherein vehicle waveform data are obtained through a geomagnetic sensor, and effective waveform characteristics are selected according to the influence of the waveform characteristics on a vehicle type identification result; and a decision tree is obtained through training by using the effective waveform characteristics and the vehicle classification function so as to further realize vehicle classification. Vehicle classification is carried out according to a three-axis geomagnetic sensor which is arranged on a road side to collect vehicle passing waveform information; the vehicle classification is carried out by extracting waveform characteristics such as passing duration, average energy and a ratio of positive energy to negative energy of an X axis and a Y axis, drawing a tree diagram and setting judgment conditions, only limited to a low-speed environment (10-30 km/h), i.e. a single-lane test scene, which is described in B. Yang et al., “Vehicle Detection and Classification for Low-Speed Condensed Traffic With Anisotropic Magnetoresistive Sensor”, IEEE Sensors Journal. A portable sensor system based on four geomagnetic sensors are arranged on a road side, the speed is estimated through cross correlation of two longitudinally arranged sensors, an average vertical magnetic height is estimated through two vertically arranged geomagnetic sensors, and vehicle classification is implemented based on a magnetic length and an average magnetic height of a vehicle, which is described in S. Taghvaeeyan et al., “Portable Roadside Sensors for Vehicle Counting, Classification, and Speed Measurement”, IEEE Transactions on Intelligent Transportation Systems.

At present, according to most vehicle classification methods, on one hand, high-cost equipment such as distributed optical fiber acoustic sensors, millimeter wave radar, cameras and the like that are adopted are not advantageous for large-scale deployment; on the other hand, a method for neural network training using machine vision or by extracting waveform characteristics is adopted, which is difficult in processing and practice; meanwhile, the sensing range of a single geomagnetic sensor or a small number of geomagnetic sensors is limited, and the omnibearing and systematic management and control of road vehicle type information are difficult to realize.

### SUMMARY OF THE INVENTION

Aiming at the defects of the existing vehicle type detection technologies, the invention provides a method for vehicle classification by utilizing multiple geomagnetic sensors, so that the cost for vehicle type detection is reduced, the installation and large-scale deployment are facilitated, and a type of a motor vehicle is accurately identified and comprehensively controlled.

In order to achieve the purpose, the invention discloses a method for vehicle classification using multiple geomagnetic sensors, which includes the following steps:

1) sequentially deploying N geomagnetic sensors on a road side at equal intervals d, and a vehicle sequentially passing by each of the sensors when it runs, wherein 2≤N≤10, 5 m≤d≤15 m;

2) N geomagnetic sensors respectively collecting magnetic field data around the sensors in real time and sequentially transmitting the magnetic field data to a data processing module, wherein the data processing module adopts a low-power-consumption microprocessor;

3) the data processing module analyzing the data transmitted by the N sensors:

3a) the data processing module judging whether or not a data mark sent by a first geomagnetic sensor indicates a vehicle: if so, judging that there is a vehicle passing by, and executing 3b), otherwise, returning to 2);

3b) the data processing module judging whether a data mark sent by a second sensor to a N^{th} geomagnetic sensor indicates there is a vehicle or not: if so, judging that there is a vehicle passing by, and executing 3c), otherwise, returning to 2);

3c) the data processing module storing data about the vehicle passing by sent by the first geomagnetic sensor to the N^{th} geomagnetic sensor, and adding a time stamp;

4) the data processing module aligning the stored data:

4a) finding out data at a time when the vehicle drives in the N geomagnetic sensors, and then finding out data at a time when the vehicle leaves the N geomagnetic sensors;

4b) respectively aligning data, i.e. first data, at an initial time when a vehicle drives in N geomagnetic sensors, and sequentially aligning second data, third data . . . and data acquired by the N^{th} sensor when the vehicle drives in, until aligning the data acquired when the vehicle leaves the N^{th} sensor, wherein M is the number of data acquired by the sensor;

5) calculating a time difference Δt_{1,2}, ×t_{2,3}, . . . , Δt_{N-1,N} obtained when the vehicle passes by two adjacent sensors among N sensors:

5a) sequentially calculating a time difference between the first data and a time difference between the second data between the first and second sensors after alignment, and a time difference between the M data until a time difference between the last data is calculated;

5b) taking an average value of the time differences among all the data, i.e. a time difference Δt_{1,2} obtained when the vehicle passes between the first sensor and the second sensor;

5c) sequentially calculating a time difference between the first data, a time difference between the second data . . . , and a time difference between the M data between the second and third sensors after alignment, until a time difference between the last data is calculated;

5d) taking a mean value of a time difference among all the data, i.e. a time difference Δt_{2,3} obtained when the vehicle passes between the second sensor and the third sensor;

5e) repeating steps 5a-5d to sequentially obtain a time difference Δt_{1,2}, Δt_{2,3}, . . . , Δt_{N-1,N} between two adjacent sensors;

6) calculating an average time

$$Δ t = \frac{Δ {t}_{1 , 2} + Δ {t}_{2 , 3} + … + Δ {t}_{N - 1 , N}}{N - 1}$$

of a vehicle passing by the two adjacent sensors according to the time difference Δt_{1,2}, Δt_{2,3}, . . . , Δt_{N-1,N}, and calculating a running speed of the vehicle:

$$v = \frac{d}{Δ t} ;$$

7) calculating a magnetic length of a vehicle when it passes by;

7a) setting an arrival threshold value and a departure threshold value of a vehicle, acquiring durations Δt₁, Δt₂, . . . , Δt_{N} of the vehicle when it passes by N geomagnetic sensors respectively according to the recorded time stamps, and calculating an average duration of the vehicle when it passes by each of the sensors:

$$Δ {t}^{′} = \frac{Δ {t}_{1} + Δ {t}_{2} + … + Δ {t}_{N}}{N} ;$$

7b) calculating a magnetic length VML: VML=v×Δt′ of a vehicle when it passes by according to a running speed v of the vehicle and an average duration Δt′ of the vehicle when it passes by each of the sensors;

8) setting a Z axis magnetic field strength threshold value S, subtracting a geomagnetic base line from Z axis magnetic field data detected by N geomagnetic sensors respectively, and detecting whether data less than the threshold value S exist; if the N geomagnetic sensors exist, marking as ‘1’, otherwise, marking as ‘0’;

9) judging vehicle classification results:

9a) setting double-threshold values L1 and L2 of the vehicle magnetic lengths, and L1>L2;

9b) comparing the magnetic length of the vehicle when it passes by with L1 and L2; if the magnetic length of the vehicle is greater than or equal to L1 when it passes by, the vehicle is judged to be a large one; if the magnetic length of the vehicle is less than or equal to L2 when it passes by, the vehicle is judged to be a small one; searching and judging whether or not the mark corresponding to the current vehicle is ‘1’ if the magnetic length of the vehicle is smaller than L1 but greater than L2 when it passes by, the vehicle is judged to be a large one, otherwise, to be a small one.

Compared with the prior art, the invention has the following advantages:

Firstly, due to the fact that multiple geomagnetic sensors are deployed on the road side at equal intervals, the vehicle type information can be accurately and timely acquired, and the level of intelligentialization of the road is improved.

Secondly, the multiple geomagnetic sensors are convenient to mount and the cost is low.

According to the invention, a geomagnetic sensor is cheaper as compared with a common Doppler radar sensor; the data processing module used in the invention can be a low-power-consumption microprocessor and is cheap.

Thirdly, the multiple geomagnetic sensors are highly reliable, and less influenced by external environmental factors.

According to the invention, a geomagnetic sensor adopted to detect surrounding magnetic field signals is not influenced by severe weather such as rain and snow, as compared with the traditional video signals such as cameras and the like, so that environmental factors have little influence on the vehicle type detection performance.

Fourthly, according to the invention, as multiple geomagnetic sensors for aligning the geomagnetic data of the vehicle passing by are adopted, as compared with the data processed by a single geomagnetic sensor, an error probability is reduced, an error with the real value is smaller, and the multiple geomagnetic sensors are more accurate and reliable.

Fifthly, the multiple geomagnetic sensors are highly sensitive, safe and environmentally-protective.

Due to the fact that the motor vehicle passing by can be detected only by placing geomagnetic sensors on the road side, it is safer to mount a geomagnetic sensor without large-scale damage to the road surface.

### BRIEF DESCRIPTION OF THE DRAWINGS

In order to illustrate the technical solutions of the embodiments of the invention more clearly, the drawings used in the description of the embodiments are briefly described below, and it is obvious that the drawings in the description below are some embodiments of the invention, and that other drawings can be obtained by a person skilled in the art without involving any inventive effort.

FIG. 1 is a flow chart of an implementation of the invention;

FIG. 2 is a schematic diagram showing deployment of multiple geomagnetic sensors according to the invention;

FIG. 3 is a schematic view illustrating data alignment of multiple geomagnetic sensors according to the invention;

FIG. 4 is a schematic diagram of geomagnetic waveforms provided by two adjacent geomagnetic sensors of the invention;

FIG. 5 is a schematic diagram of a Z axis magnetic waveform when different types of vehicles pass by according to the invention.

### DETAILED DESCRIPTION OF THE INVENTION

Embodiments of the invention will now be described more fully hereinafter with reference to the accompanying drawings, in which it is apparent that the described embodiments are only a few, but not all embodiments of the invention. Based on the embodiments of the invention, all other embodiments obtained by a person skilled in the art without involving any inventive effort are within the scope of the invention.

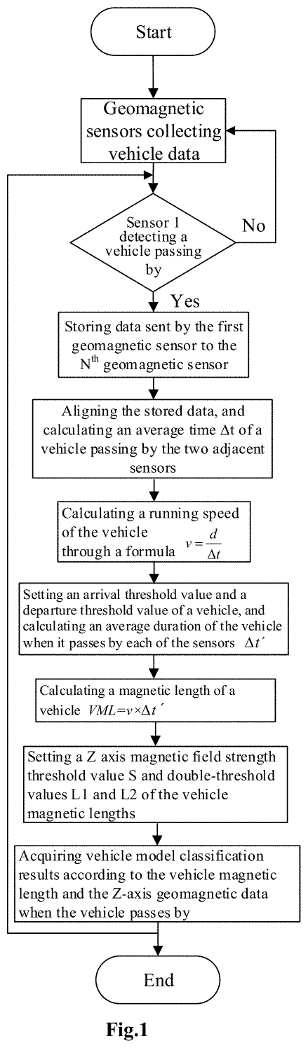

Referring to FIG. 1, the method for vehicle classification using the multiple geomagnetic sensors of the present example is implemented as follows:

Step 1, multiple geomagnetic sensors are deployed according to actual requirements.

The multiple geomagnetic sensors are composed of N geomagnetic sensors and are deployed on the road side at equal intervals, connection modes between the N sensors and the data processing module are diversified, and all wireless communication modes can be included through wired connection or wireless connection. A distance between the sensors is set according to the actual situation of the road to be measured or the magnitude of the sensor system, the distance range is 5-15 m, and the time difference of the vehicle passing by the two sensors can be obtained through the deployment distance of the two adjacent geomagnetic sensors so as to obtain a speed of a vehicle. The geomagnetic sensor includes a digital geomagnetic sensor, an analog geomagnetic sensor, a single-axis geomagnetic sensor and a multi-axis geomagnetic sensor. The present example adopts RM 3100 digital three-axis geomagnetic sensors, but is not limited to other geomagnetic sensors in the market, large dynamic range linear sensors, which can indicate that the sensors in which the geomagnetic field varies are neither limited to single-axis, multi-axis geomagnetic sensors, nor geomagnetic sensors using digital and analog signals.

In practice, a geomagnetic sensor is deployed on a building or a road surface on one side of a road according to actual requirements, and the geomagnetic sensor can classify the types of vehicles no matter on one side of the road or the road surface.

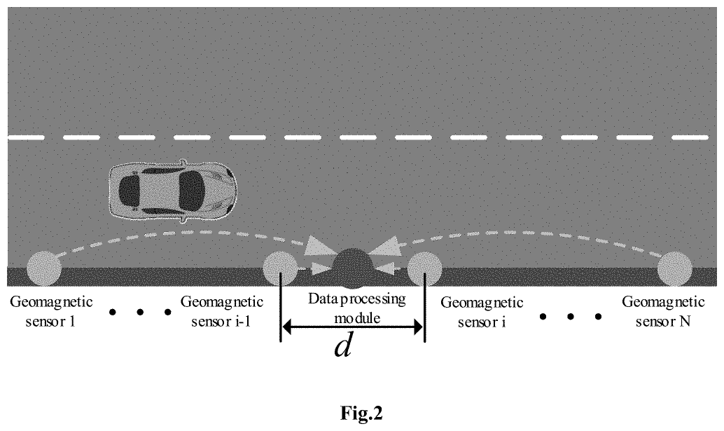

Referring to FIG. 2, according to the present example, N geomagnetic sensors are deployed on one side of a road, and each geomagnetic sensor is sequentially arranged, i.e. a vehicle firstly passes by a first sensor 1, then passes by a second sensor 2, and finally passes by a N^{th} sensor. The number N and the distance d of the geomagnetic sensors are correspondingly adjusted according to actual road requirements and technical requirements, meanwhile the embodiment is set as not to be limited to N=5, two adjacent sensors are set as not to be limited to d=10 m to mount according to the distance, and the communication mode between the geomagnetic sensors and the data processing module is set to be wired communication or wireless communication according to the requirements. This example uses wired communication. The power supply modes of the geomagnetic sensor and the data processing module can be all power supply modes of solar energy, wind energy, commercial power and the like, so that the geomagnetic sensor and the data processing module can realize uninterrupted work for 24 hours.

Step 2, multiple geomagnetic sensors collect surrounding geomagnetic field data.

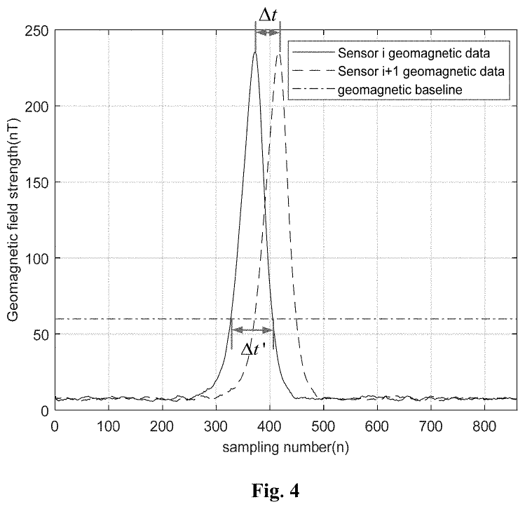

As shown in FIG. 4, the waveform of the geomagnetic sensor varies with the vehicle passing by the road surface, i.e. when the vehicle passes by, data fluctuation of the geomagnetic field in the first sensor 1 is caused firstly, then the data fluctuation of the geomagnetic field of the second sensor 2 is caused, and finally the data fluctuation of the geomagnetic field of the fifth sensor 5 is caused. The five geomagnetic sensors acquire the data of the local magnetic field in real time, and the obtained data are transmitted to the data processing module through the communication mode in step 1 for processing.

The magnetic field data refer to fluctuation magnetic field data at a time when a vehicle passes by and relatively stable magnetic field data at a time when no vehicle passes by, which are detected by all the geomagnetic sensors, wherein the fluctuation range of the magnetic field when a vehicle passes by exceeds 50 nT and the fluctuation range of the magnetic field when no vehicle passes by does not exceed 20 nT.

The data processing module is mainly composed of a low-power-consumption processor and some peripheral circuits. According to the example, the low power processor is a processor of M3 series based on ARM architecture, but is not limited to other series of processors based on ARM authorization, which further includes a series of processors designed based on X86 and an ultra low power processor of MSP430 series.

Step 3, the data processing module analyzes the data transmitted by the five geomagnetic sensors and judges whether a vehicle passes by or not.

3.1) According to the fluctuation condition of the magnetic field data in the first geomagnetic sensor 1, the data processing module judges that a vehicle passes by if 10 continuous data fluctuations of the magnetic field data of the first sensor 1 exceeds 60 nT, saves the geomagnetic data at a time when the vehicle passes by, and executes step 3.2), otherwise, returns to step 2; and

3.2) the data processing module further judges whether or not the data marks sent by the second to fifth geomagnetic sensors indicate there is a vehicle, and the judgment mode is the same as that of step 3.1): if so, judging that a vehicle passes by, storing the part of geomagnetic data, otherwise, returning to step 2; and

Step 4, the data processing module adds a time stamp to the stored geomagnetic data.

4.1) When the vehicle passes by, the data processing module finds an initial moment t₀ when the vehicle reaches the detection range of the sensor, and acquires data one time at a time to acquire time information, wherein the time information refers to an instantaneous time of the moment when the sensor acquires geomagnetic data, and the method for acquiring the time can be acquired by a clock module of the processor and also can be acquired according to the time information in an instruction issued by a base station module.

The time information obtained in the example is acquired by the clock module in a processor, i.e. a sampling interval is acquired by a formula

$$T = \frac{1}{f}$$

according to a sampling frequency f of the magnetic field through the time t₀ of the first geomagnetic data, and the time of each data is acquired through the time interval nT of the n geomagnetic data and the first geomagnetic data: tₙ=t₀+nT;

4.2) the time information acquired in step 4.1) is sequentially added into the corresponding magnetic field data until the vehicle leaves the last geomagnetic sensor 5.

Step 5, multiple geomagnetic data are aligned by the data processing module.

5.1) the data processing module firstly finds data at a time when a vehicle respectively drives in the five geomagnetic sensors, then finds data at a time when the vehicle leaves the five geomagnetic sensors, takes data at a time when the vehicle initially drives in a first sensor 1 to a fifth sensor 5 as first aligned data, and takes data at a time when the vehicle leaves the first sensor 1 to the fifth sensor 5 as last aligned data;

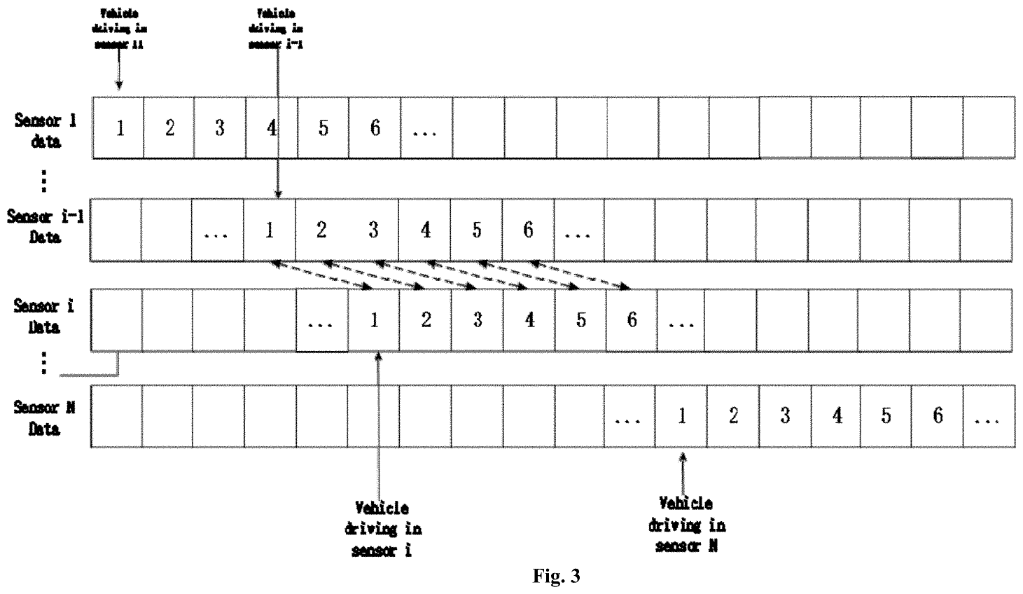

5.2) the first data, the second data, and the third data . . . of the first sensor 1 through the fifth sensor 5 are aligned, until the last data are aligned, as shown in FIG. 3.

Step 6, an average time difference Δt obtained when a vehicle passes by the two adjacent sensors is calculated.

6.1) In the aligned data acquired in step 5, the time information of the first data t₁₁, the second data t₁₂ and the third data t₁₃ . . . of the first sensor 1 and the time information of the first data t₂₁ the second data t₂₂ and the third data t₂₃ . . . of the second sensor 2 are subtracted, and an average value is calculated to obtain a difference Δt_{1,2} between each of the data of the first sensor 1 and the second sensor 2;

6.2) similarly, a time difference Δt_{2,3} between the second sensor 2 and the third sensor 3, a time difference Δt_{3,4} between the third sensor 3 and the fourth sensor 4, and a time difference Δt_{4,5} between the fourth sensor 4 and the fifth sensor 5 are sequentially obtained, and an average time difference Δt of the vehicle passing by two adjacent sensors in the five geomagnetic sensors is calculated as:

$$Δ t = \frac{1}{4} {\sum }_{i = 1}^{4} Δ {t}_{i , i + 1} .$$

Step 7, a vehicle speed V is calculated.

A distance d between two adjacent sensors is obtained according to step 1 and an average time difference Δt between the two adjacent sensors after the vehicle passes by step 6, and a running speed of the vehicle is obtained by calculation:

$$v = \frac{d}{Δ t} .$$

Step 8, a magnetic length of the vehicle when it passes by is calculated.

8.1) durations Δt₁, Δt₂, . . . , Δt₅ of the vehicle respectively passing by the five geomagnetic sensors are acquired according to the set threshold value of the magnetic field data of the arrival and departure of the vehicle and the recorded time stamp;

8.2) an average duration Δt′ of the vehicle passing by each of the sensors is calculated:

Δt′=⅕(Δt₁+Δt₂+ . . . +Δt₅)

8.3) a magnetic length VML of a vehicle passing by is calculated according to a running speed v of the vehicle and an average duration Δt′ of the vehicle passing by each of the sensors:

VML=v×Δt′.

Step 9, a Z axis magnetic field strength threshold value is set and marked.

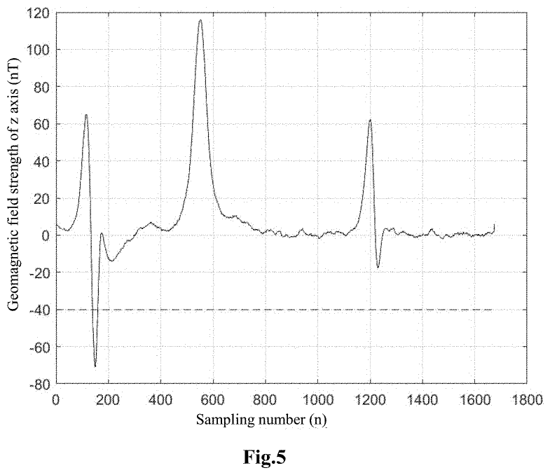

9.1) Z axle magnetic field data of 5 geomagnetic sensors are acquired, and a Z axle magnetic field intensity threshold value is set as S, as shown in FIG. 5, S=−40 is set in the example; since magnetic field distribution under different road environments is different and different types of vehicles can generate different Z axis magnetic field waveforms when passing by, the threshold value S can be correspondingly set according to the geomagnetic waveforms obtained when different types of vehicles pass through an actual road, and only the Z axle magnetic field waveforms generated when different types of vehicles pass by are obviously differed;

9.2) the geomagnetic baseline of the local magnetic field is respectively subtracting from the Z axial magnetic field data detected by the five geomagnetic sensors, the waveform data are recorded, whether or not at least one data is lower than a set threshold value S exists in the waveform data, if at least one data lower than the set threshold value S exists in the waveform data of the five geomagnetic sensors, it is marked as ‘1’, indicating that the vehicle might have been a large one and laying a basis for finally judging the types of vehicles; otherwise, it is marked as ‘0’.

Step 10, vehicle classification results are judged.

10.1) double-threshold values L1 and L2 are set, and L1>L2;

Different types of vehicles will generate different vehicle magnetic lengths, i.e. the vehicles with particularly large vehicle lengths tend to generate larger vehicle magnetic lengths, which are generally referred to as large vehicles; the vehicles with particularly small vehicle lengths tend to generate smaller vehicle magnetic lengths, which are generally referred to as small vehicles; and the vehicles with medium vehicle lengths tend to generate medium vehicle magnetic lengths, so that it is difficult to distinguish whether the vehicle is a large one or a small one, and therefore the setting of the double threshold values L1 and L2 can be obtained by dividing the magnetic lengths of different types of vehicles passing by into different regions.

10.2) the magnetic length VML of the vehicle when it passes by is compared with double-threshold values L1 and L2:

if the magnetic length of the vehicle when it passes by is VML≥L1, the vehicle is judged to be a large one;

if the magnetic length of the vehicle when it passes by is VML≤L2, the vehicle is judged to be a small one;

If the magnetic length of the vehicle when it passes by satisfies L2≤VML≤L1, a further judgment is made according to the Z axis magnetic field waveform thereof, i.e. whether or not the mark corresponding to the current vehicle is ‘1’ is searched, and if so, the vehicle is judged to be a large one; otherwise, to be a small one.

The example realizes an overall target of low power consumption, low cost, high reliability, easiness in realization and strong applicability, realizes the intelligent and information construction of the deployment area, is suitable for the construction of intelligent roads, and plays a significant role in assisting unmanned safety; according to the example, road vehicle type information can be accurately collected in real time by deploying the multiple geomagnetic sensors; in addition, an omnibearing management and control of the vehicles running on the road can be further realized through large-scale low-cost deployment of the geomagnetic sensors.

While the invention has been particularly shown and described with reference to a preferred embodiment thereof, it will be understood by a person skilled in the art that various changes in form and details may be made therein without departing from the spirit and scope of the invention as defined by the appended claims. The scope of the invention should, therefore, be determined with reference to the appended claims.

1. A method for vehicle classification using multiple geomagnetic sensors, wherein, the method comprises the following steps:
1) sequentially deploying N geomagnetic sensors on a road side at equal intervals d, and a vehicle sequentially passing by each of the sensors when it runs, wherein 2≤N≤10, 5 m≤d≤15 m;
2) N geomagnetic sensors respectively collecting magnetic field data around the sensors in real time and sequentially transmitting the magnetic field data to a data processing module, wherein the data processing module adopts a low-power-consumption microprocessor;
3) the data processing module analyzing the data transmitted by the N sensors:
3a) the data processing module judging whether or not a data mark sent by a first geomagnetic sensor indicates a vehicle: if so, judging that there is a vehicle passing by, and executing 3b), otherwise, returning to 2);
3b) the data processing module judging whether a data mark sent by a second sensor to a N^{th} geomagnetic sensor indicates there is a vehicle or not: if so, judging that there is a vehicle passing by, and executing 3c), otherwise, returning to 2);
3c) the data processing module storing data about the vehicle passing by sent by the first geomagnetic sensor to the N^{th} geomagnetic sensor, and adding a time stamp;
4) the data processing module aligning the stored data:
4a) finding out data at a time when the vehicle drives in the N geomagnetic sensors, and then finding out data at a time when the vehicle leaves the N geomagnetic sensors;
4b) respectively aligning data, i.e. first data, at an initial time when a vehicle drives in N geomagnetic sensors, and sequentially aligning second data, third data . . . and M data acquired by the N^{th} sensor when the vehicle drives in, until aligning the data acquired when the vehicle leaves the N^{th} sensor, wherein M is the number of data acquired by the sensor;
5) calculating a time difference Δt_{1,2}, Δt_{2,3}, . . . , Δt_{N-1,N} obtained when the vehicle passes by two adjacent sensors among N sensors:
5a) sequentially calculating a time difference between the first data and a time difference between the second data between the first and second sensors after alignment, and a time difference between the M data until a time difference between the last data is calculated;
5b) taking an average value of the time differences among all the data, i.e. a time difference Δt_{1,2} obtained when the vehicle passes between the first sensor and the second sensor;
5c) sequentially calculating a time difference between the first data, a time difference between the second data . . . , and a time difference between the M data between the second and third sensors after alignment, until a time difference between the last data is calculated;
5d) taking a mean value of a time difference among all the data, i.e. a time difference Δt_{2,3} obtained when the vehicle passes between the second sensor and the third sensor;
5e) repeating steps 5a-5d to sequentially obtain a time difference Δt_{1,2}, Δt_{2,3}, Δt_{N-1,N} between two adjacent sensors;
6) calculating an average time
$$Δ t = \frac{Δ {t}_{1 , 2} + Δ {t}_{2 , 3} + … + Δ {t}_{N - 1 , N}}{N - 1}$$
of a vehicle passing by the two adjacent sensors according to the time difference Δt_{1,2}, Δt_{2,3}, . . . , Δt_{N-1,N} and calculating a running speed of the vehicle:
$$v = \frac{d}{Δ t} ;$$
7) calculating a magnetic length of a vehicle when it passes by;
7a) setting an arrival threshold value and a departure threshold value of a vehicle, acquiring durations Δt₁, Δt₂, . . . , Δt_{N} of the vehicle when it passes by N geomagnetic sensors respectively according to the recorded time stamps, and calculating an average duration of the vehicle when it passes by each of the sensors:
$$Δ {t}^{′} = \frac{Δ {t}_{1} + Δ {t}_{2} + … + Δ {t}_{N}}{N} ;$$
7b) calculating a magnetic length VML: VML=v×Δt′ of a vehicle when it passes by according to a running speed v of the vehicle and an average duration Δt′ of the vehicle when it passes by each of the sensors;
8) setting a Z axis magnetic field strength threshold value S, subtracting a geomagnetic base line from Z axis magnetic field data detected by N geomagnetic sensors respectively, and detecting whether data less than the threshold value S exist; if the N geomagnetic sensors exist, marking as ‘1’, otherwise, marking as ‘0’;
9) judging vehicle classification results:
9a) setting double-threshold values L1 and L2 of the vehicle magnetic lengths, and L1>L2;
9b) comparing the magnetic length of the vehicle when it passes by with L1 and L2; if the magnetic length of the vehicle is greater than or equal to L1 when it passes by, the vehicle is judged to be a large one; if the magnetic length of the vehicle is less than or equal to L2 when it passes by, the vehicle is judged to be a small one; searching and judging whether or not the mark corresponding to the current vehicle is ‘1’ if the magnetic length of the vehicle is smaller than L1 but greater than L2 when it passes by, the vehicle is judged to be a large one, otherwise, to be a small one.

2. The method according to claim 1, wherein: the geomagnetic sensor is selected from any one of a digital geomagnetic sensor, an analog geomagnetic sensor, a single-axis geomagnetic sensor and a multi-axis geomagnetic sensor.

3. The method according to claim 1, wherein: the magnetic field data in step 2) refers to fluctuation magnetic field data at a time when a vehicle passes by and relatively stable magnetic field data at a time when no vehicle passes by, which are detected by all the geomagnetic sensors, wherein the fluctuation range of the magnetic field when a vehicle passes by exceeds 50 nT, and the fluctuation range of the magnetic field when no vehicle passes by does not exceed 20 nT.

4. The method according to claim 1, wherein, the time stamp in 3c) refers to an instantaneous time at which the geomagnetic data is acquired by the sensor, and the instantaneous time is acquired by a clock module in the central processing or by time data uniformly transmitted by the base station.

5. The method according to claim 1, wherein, the data in 4b) are aligned at an initial time when the vehicle drives in a monitoring range of N geomagnetic sensors, at a time when the vehicle leaves N geomagnetic sensors, or at a time when the geomagnetic characteristics of N geomagnetic sensors are most obvious, i.e. at a time when the geomagnetic data fluctuate highest or at a time when the geomagnetic data fluctuate lowest.

6. The method according to claim 1, wherein, the vehicle magnetic length in 7) refers to a product of a time when a magnetic field disturbance is caused by the vehicle and a speed of the vehicle.
